(19) United States
(12) Patent Application Publication
(10) Pub. No.: US 2006/0174828 A1
(43) Pub. Date: Aug. 10, 2006

(54) Processing system with multi-chamber pump, and related apparatus and methods

(76) Inventor: Kader Mekias, Sachse, TX (US)

Correspondence Address: Kagan Binder, PLLC, Suite 200, 221 Main Street North, Stillwater, MN, 55082, US

(21) Appl. No.: 11/053,722

(22) Filed: Feb. 7, 2005

(51) Int. Cl. B05C 11/02

(52) U.S. Cl. 118/52; 118/66

(57) ABSTRACT

Described are apparatus, equipment, systems, architecture, and methods for dispensing one or more process fluids to one or more processing stations, involving the use of at least one a multi-chamber pump, including an embodiment for spin-coating microelectronic or semiconductor substrates.

### FIELD OF THE INVENTION

The invention relates to systems, methods, and apparatuses useful in dispensing fluids, especially but not necessarily as applied to high precision process fluid delivery, and especially but not exclusively with applications for dispensing process fluids in microelectronic device processing, e.g., spin coating applications.

### BACKGROUND

Various commercial and industrial processes involve flow control, pumping, storage, movement, or dispensing of fluids, often requiring or with benefit from high precision. An example is processing of semiconductor wafers or microelectronic devices, which are processed to be cleaned, coated, and recycled. Processing steps can involve dispensing onto a substrate a fluid such as a photoresist material, a developer, a spin-on dielectric material, an etchant, a solvent, a cleanser, water, or another useful solution. The substrate may include a semiconductor material or assembly, a thin-film “read-write” head, a flat panel display substrate, a fiber optic modulator substrate, or similar known microelectronic materials.

For many reasons, some of which may relate to cost, quality control, coating uniformity, or general manufacturing efficiency, it can be desirable in many specific applications to precisely control the amount (e.g., mass or volume) or timing of a fluid applied to a substrate. For example, in spin-coating microelectronic devices, application of a precisely accurate amount, with precise timing, of a photoresist material or a subsequent developing solution, can result in highly accurate and uniform thicknesses of each applied material, allowing very high uniformity of the photoresist and developer coatings, and ultimately allow quality and consistency in a microelectronic device produced. A different motivation for precise control of an amount of a fluid can be present if a particular fluid is a cost-expensive component of a process, such as can also be the case for photoresist materials and other materials involved in processing microelectronic devices.

For reasons such as convenience, cost-control, efficiency, and inventory and process control, apparatus and equipment useful to dispense fluids to processing stations are often set up to include a number of separate processing stations and appurtenant equipment that collectively manage a semi-continuous or continuous flow of processing materials such as process fluids, substrates, or other units or flows of parts or pieces involved in the processing. These collections of equipment may contain a series of different pieces of equipment, such as a series of pumps; filters; solution storage reservoirs; and piece or substrate handling, processing, or coating stations; that may operate in parallel starting from a common position or raw material.

FIG. 1 illustrates an example of a system for managing the flow of multiple (seven as illustrated) different process fluids, to dispense each fluid at multiple (four as illustrated) separate processing (e.g., coating) stations. Starting from the left side of the figure, seven process fluids are represented by fourteen (2×7) source bottles (or “supply containers” or “reservoirs”) 2. The source bottles 2 are used to maintain a separate supply of each process fluid, at least one supply container for each process fluid. FIG. 1 illustrates two supply containers for each process fluid, which is common practice although not required. Each supply container or appurtenant equipment (e.g., a mass measuring device or “level sensing reservoir”) (10) provides capability of sensing the level of fluid in the container or reservoir, to monitor the level and detect, e.g., an empty or nearly empty state.

Downstream from the separate process fluid containers 2 are pumps 4 that separately transport each process fluid to each of the stations 6. As shown in FIG. 1, each of 28 pumps 4, is useful to control the flow of only a single process fluid, i.e., one pump 4 is used to supply a separate flow of each of the seven process fluids to each of the four coater stations 6. Based on this arrangement, twenty-eight (seven times four) individual pumps are used to supply seven process fluids to each of four individual processing stations. Conventionally, one filter, 8, between each pump 4 and station 6 is used to filter each separate flow of process fluid between each of the twenty-eight pumps and each of the four stations, meaning that 28 filters are used to supply seven process fluids to four separate coater stations. As illustrated and as is typical, the filters 8 are downstream from the pumps 4, because the pumps may introduce contaminants to the flow of a process fluid. Industry preference can be for this type of arrangement, with downstream or “point of use” filtration, because typical pumps have the potential to introduce contaminants or particulates into a process fluid, e.g., due to the presence of seams, gaskets, seals, torturous paths, or high numbers of valves with moving parts, etc.

The cost and complexity of an arrangement as show at FIG. 1, with each of its individual components, including a pump and filter for each process fluid flow to each station, is quite substantial, but commercially tolerated due to lack of alternatives. Each pump that is used to supply a station with a process fluid can cost in the range of thousands of dollars. Every filter used to treat a single flow of process fluid is also of a very substantial cost, e.g., hundreds of dollars per filter, and each filter is typically replaced after every few months of use.

Cost reductions are always desirable. Industry continues to search for new methods and equipment that offer improved and more cost-effective methods of dispensing fluids, especially with very accurate and precise control of the amount (e.g., volume or mass) of a fluid dispensed. Substantial cost and complexity of processing systems that use multiple processing stations, each of which dispense multiple process fluids, would be reduced by eliminating or simplifying any aspect of this system, such as by simplifying or reducing the number of pumps or filters necessary to dispense a given number of fluids to a given number of stations.

In addition to cost, quality is an important issue relating to systems and equipment used to dispense process fluids to processing stations, e.g., onto substrates. With particular regard to microelectronics, systems for coating microelectronic devices or their precursors must do so with an ever-decreasing amount of foreign particles present at substrate surfaces. Industry therefore also is in search of methods and equipment capable of processing microelectronic substrates to include ever-reduced amounts of surface contaminants or surface defects.

### SUMMARY OF THE INVENTION

The invention relates generally to apparatuses, systems, architectures (these terms are sometimes used interchangeably) and related methods for dispensing multiple fluids or solutions at processing stations. The apparatuses can be useful for dispensing any type of fluids, and may be particularly useful for applying process fluids in the liquid form, such as solutions, suspensions, mixtures, etc., to microelectronic devices and their precursors, especially semiconductor wafer substrates for spin-coating. Still, the invention may be applied to other areas of technology or used within any industry where it is desired to precisely handle multiple flows of fluids. By “dispensing,” it is meant that a process fluid can be caused to flow for any useful purpose, such as to flow to a processing apparatus for processing a substrate, either directly at a surface of a substrate or generally in the interior space of the processing apparatus.

The methods, systems, and apparatuses relate in general to the use of a multi-chamber pump to control more than a single flow of process fluid. The ability to use one pump unit to control more than one flow of process fluid, compared to a single pump to control only a single flow of process fluid, allows substantial reduction in the cost of systems that use multiple processing stations to dispense various process fluids. A variety of new arrangements of equipment are possible using multi-chamber pumps, with certain improved arrangements requiring fewer individual components (e.g., fewer pumps, fewer filters) to supply a given number of processing stations with a given number of process fluid flows.

As explained in more detail later in this description, embodiments of the invention allow a number of multi-chamber pumps used in a particular system or architecture to be selected to correspond (roughly or exactly) to the number of different process fluids in a system. In other embodiments, a number of pumps can correspond (roughly or exactly) to the number of individual processing stations to which different process fluids are supplied. According to the former embodiment, one multi-chamber pump can roughly or exactly correspond to a single processing station, and each pump can contain multiple chambers that control flow of multiple different types of process fluids to a single processing station. Exemplary arrangement are shown at FIGS. 2, 2a, and 2b, but other embodiments are also possible. According to the latter arrangement identified above, one multi-chamber pump can roughly or exactly correspond to a single type of process fluid or process fluid reservoir, and the pump can contain multiple chambers that control different flows of the same process fluid, for supply of separate flows of a same process fluid to a number of different processing stations. Examples of such an arrangement are shown at FIGS. 3 and 4.

Processing stations can be the same or different, such as (generally) any type of a coating station or a spin-coating station (e.g., a photoresist coat station, a developer coat station, or others), a surface conditioning station, or others as will be appreciated.

A process fluid can be any liquid or gaseous fluid material used in industrial processing. For processing microelectronic device substrates using a spin-coater, as specifically exemplified herein, useful fluids include photoresist materials, developer solutions, any type of solvent or cleaner, water, surface conditioning materials such as acids and bases, other useful process fluids, and mixtures thereof.

The pump is a pump that can control the flow of more than one fluid, such as a multi-chamber pump that contains multiple membranes or chambers, each of which can be separately controlled to effect a flow of process fluid. An example of such a pump can contain multiple process chambers within a single control chamber. Pressure differentials and valves (internal or external to the pump) can be used to independently control the separate flows of process fluid through each process chamber, e.g., based on pressure of a control fluid in the control chamber, e.g., into and out of, or through, the control chamber. The volume of each process chamber can be separately controlled by functions that include increasing or decreasing an amount, volume, or pressure of a control fluid within the control chamber. The volume of a control chamber may itself be controlled and varied, but can be fixed according to certain embodiments of the invention. An inlet of each process chamber can be connected through a valve to a process fluid reservoir, and an outlet of each process chamber can be connected through a valve to a location of dispense such as a processing station, e.g., a microelectronic device manufacturing apparatus such as a spin coating apparatus.

Preferred embodiments of the invention can offer advantages in terms of cost, efficiency, and quality of processing. For example, use of a multi-chamber pump as discussed herein can reduce the total number of pumps (pump units) required to supply a given number of process fluids to a given number of processing stations. The overall cost of constructing and maintaining systems according to the invention will be reduced compared to systems that use one pump for each flow of process fluid supplied to each one of a number of processing station, i.e., a total number of pumps that is at least equal to the number of process fluids multiplied by the number of processing stations.

Specific embodiments of the invention include the use of simplified, multi-chamber pumps that can result in reduced introduction of contaminants to a flow of process fluid. Many conventional pumps used for industrial processing methods include pressure vessels, diaphragm pumps, centrifugal pumps, bellows pumps, among others. These types of pumps may contain highly complex and fast-moving parts that can tend to produce minute particles that separate into a process fluid being pumped, e.g., from stationary or moving parts within the pump, such as diaphragm seams, gaskets, seals, tortuous paths, excessive number of valves with moving parts, etc. Alternately, instead of complex pumps, a pressurized vessel may be used to produce a flow of process fluid. However, when used, a pressure vessel can result in the diffusion of a pressurizing gas into the process fluid, requiring additional equipment downstream for de-gassing.

According to certain specific embodiments of the present invention, certain preferred multi-chamber pumps can expose a flow of process fluid to a reduced amount of moving parts, and to parts that move reduced distances or more slowly, therefore reducing the amount of particulate contaminants generated by the pump that can become introduced to the flow of a process fluid being pumped. A flow of process fluid can be controlled, e.g., through a process chamber of a multi-chamber pump, wherein the process chamber is an elongate hollow tube that can expand and contract to change in volume and create flow. Such a simple tube can produce flow with very little deformation (or flex) of the tube material, and by the use of a straight fluid path. These features result in a reduced potential for particulates to be created and introduced to the flow of process fluid being pumped. Particularly preferred pump chambers can be prepared from materials that have a reduced tendency for producing particulate contaminants, e.g., Teflon. Additionally or alternately, a process chamber of particularly preferred multi-chamber pumps can be sized and dimensioned to reduce the amount of movement (and deformation of the tube material) required of the process chamber to produce a flow of process fluid, thereby reducing the amount of contaminant particles produced by the pump and introduced to the process fluid flow. Also according to preferred embodiments, flow of process fluid through the pump, e.g., process chamber, can be in a straight flow path, again reducing the potential for contamination.

As a related advantage, the use of multi-chamber pumps as described can allow for consolidation of a flow of process fluid between a source of process fluid and a pump, in a way that can allow a reduction in the number of filters required for a processing system. According to the invention, filters can be placed upstream from a multi-chamber pump, e.g., because of the nature of the multi-chamber pump and its reduced propensity to introduce contaminants to a flow of process fluid. Embodiments of multi-chamber pumps as described herein have been shown to introduce a reduced amount of particles to a flow of process fluid, with a degree of reduction that is enough so that a filter can be moved to a position that is upstream from the pump (instead of the conventional downstream position), which allows for a reduction in the number of total filters required.

Additionally, systems and architectures of the invention can result in a reduced amount of area or “footprint” needed for a total apparatus or system. By reducing the total number of pumps and filters required to operate a processing system, the size of the area or “footprint” needed to accommodate pumps and filters is reduced. Advantages of reduced footprint are apparent, especially for use in cleanroom applications, such as reduced cost of cleanroom space. Still other advantages can also exist based on specific applications of the invention. For example, in microelectronic coating applications, when large numbers of pumps and filters are required, each must be connected to a coating station. It is generally advantageous to reduce distance between a pump and a coating station to reduce flow mechanics challenges such as outgassing of the process fluid in a long plumbing line. Also, longer lines add cost and inhibit precise control of flow. The use of a multi-chamber pump as described can reduce the size of total pump and filter space needed, allowing the pump to be placed nearer to a coating station, which reduces cost, complication, and lengths of plumbing lines, and which gives better control of the flow dynamics and faster and more precise dispense.

An aspect of the invention relates to an apparatus for processing substrates. The apparatus includes: two processing stations equipped to dispense at least two different process fluids, and two multi-chamber pumps each comprising two process chambers, each process chamber in fluid communication with a processing station.

In another aspect, the invention relates to processing apparatus that includes: two processing stations, and a multi-chamber pump comprising two process chambers, one process chamber in fluid communication with each processing station.

In another aspect, the invention relates to an architecture for dispensing multiple process fluids to multiple processing stations. The architecture includes: two or more processing stations, each station dispensing multiple process fluids, each station in fluid communication with at least one multi-chamber pump; and two or more multi-chamber pumps that have multiple chambers, each chamber having an inlet and an outlet, the inlet in fluid communication with a reservoir of process fluid, and the outlet in fluid communication with a processing station.

In another aspect, the invention relates to a processing method. The method includes: providing two processing stations, each station equipped to dispense two or more process fluids, providing a multi-chamber pump for each processing station, each pump supplying two or more process fluid flows to a processing station, and dispensing process fluid to a processing station through the multi-chamber pump.

In yet another aspect, the invention relates to a processing method that includes: providing two multi-chamber pumps; providing two different process fluids, one process fluid in communication with a process chamber of each multi-chamber pump; and dispensing both of the two process fluids to a single processing station.

### BRIEF DESCRIPTION OF THE DRAWINGS

FIG. 1 schematically illustrates a prior art arrangement of multiple process fluid flows to multiple processing stations.

FIG. 2 schematically illustrates an embodiment of the invention that includes an arrangement of multiple process fluid flows through four multi-chamber pumps, into multiple processing stations.

FIGS. 2a, 2b, and 2c schematically illustrate systems of the invention that involve multiple fluid flows through embodiments of a multi-chamber pumps, with appurtenances.

FIG. 3 schematically illustrates an embodiment of the invention including an arrangement of two process fluid flows through an embodiment of a single multi-chamber pump, to different processing stations.

FIG. 4 schematically illustrates one specific embodiment of the arrangement of FIG. 3.

FIG. 5 schematically illustrates a cross-sectional view of an embodiment of a multi-chamber pump.

FIG. 6 schematically illustrates a system that includes fluid reservoirs in series.

FIG. 7 schematically illustrates a system that includes fluid reservoirs in parallel.

FIG. 8 schematically illustrates a membrane-type reservoir.

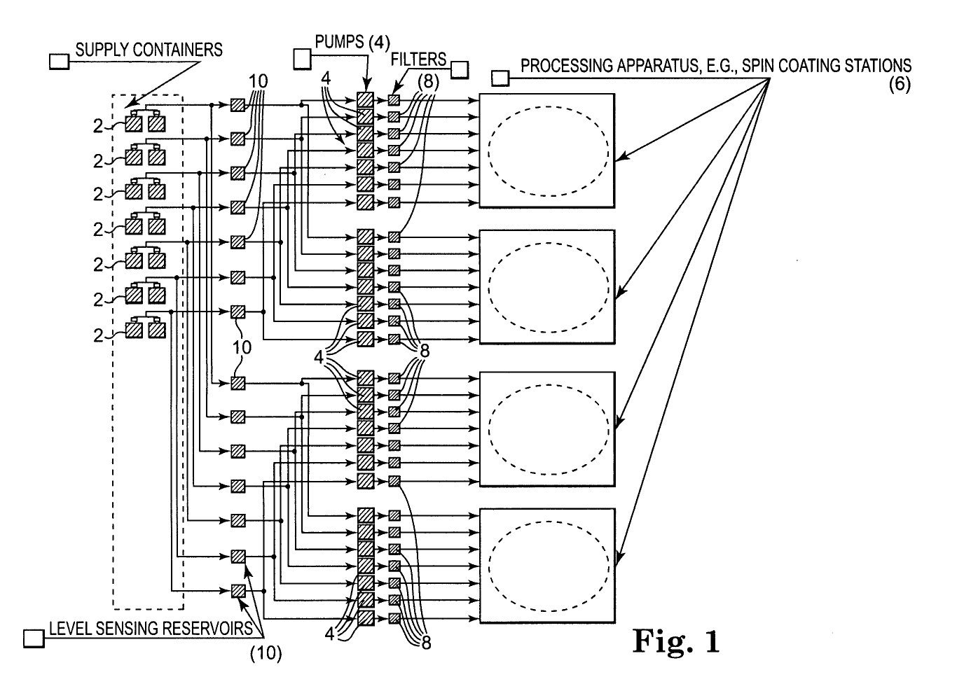

### DETAILED DESCRIPTION

The invention relates to the use of one or multiple multi-chamber pumps to control at least two flows of the same or different process fluids. The fluids may, according to specific embodiments, be used in a system to process substrates. A processing system may be an arrangement of equipment useful to organize multiple flows of one or more process fluid or fluids for use in any useful processing method or technique, e.g., coating, conditioning, or otherwise processing a desired article or substrate. A processing “system” may include one or multiple supplies of process fluid in combination with one or multiple multi-chamber pumps, multiple dispense lines, and one or multiple processing stations (e.g., coat stations such as spin-coating stations), as well as related appurtenances such as filters, electronics, and process control equipment, etc. Optionally, the same system can include other additional equipment such as other processing stations, non-multi-chamber pumps, and appurtenances, that do not necessarily involve the need for use of a multi-chamber pump. Generally, systems according to the invention use equipment as described herein to dispense different types of process fluids to one or multiple processing stations, e.g., at the interior of the processing station or at a substrate surface for processing a substrate such as a microelectronic device. A particular example of such a system is a system that includes a variety of process fluids separately contained in multiple process fluid reservoirs, and in communication through fluid supply lines with multiple multi-chamber pumps that independently and separately supply the process fluids to multiple processing stations.

A processing station may be any type of processing apparatus or unit. An example is a coating or processing station useful for coating or processing a substrate such as a microelectronic device, a semiconductor wafer, or the like, such as a spin-coating station for placing process fluids onto a substrate by a spin-coating method. Especially useful according to the invention are methods that include processing stations used in processing microelectronic devices, particularly in applications that call for or benefit from precise dispensing of a process fluid. Examples of such processing stations are generally known and commercially available, and include spin-coating apparatus such as those described, for example, in Assignee's copending U.S. patent application Ser. No. 09/583,629, entitled “Coating Methods and Apparatuses for Coating,” filed May 31, 2000; and Assignee's U.S. Pat. No. 6,599,560 entitled “Liquid Coating Device with Barometric Pressure Compensation,” granted Jul. 29, 2003; the entire disclosures of each of these are incorporated herein by reference.

The process fluid can be any fluid material useful to a processing apparatus. The process fluid may be useful as applied or coated onto, or contacted with, a substrate, e.g., for processing, manufacturing, or use. Alternately, a process fluid may be useful within a processing station for reasons that do not require application to or contact with a substrate surface, e.g., for cleaning the station.

A variety of substrates, especially microelectronic devices, can be processed according to the inventive processes and using the inventive equipment and designs, including but not limited to microelectronic substrates such as integrated semiconductor circuits (e.g., semiconductor wafers), display screens comprising liquid crystals, electric circuits on boards of synthetic material (circuit boards), and other commercially significant microelectronic-related materials and products, as will be appreciated by those of skill.

Exemplary process fluids for microelectronic applications may include photoresist materials and developer solutions used in photolithographic methods; other materials applied by spin-coating techniques such as dielectric materials, spin-on glass, spin-on dopants, low-k dielectrics, or a subsequently-applied developing solution; cleaning materials, etchants, and materials useful for surface conditioning such as solvents and acidic or basic materials; and any other material that can be used in processing a substrate, especially where it is useful or desirable to precisely control an amount of the process fluid dispensed, and, e.g., introduced to a processing station or applied to a substrate. As just a single example, certain embodiments of methods and apparatus according to the invention relate to applying a photodefinable spin-on dielectric material (e.g., a polyimide or any other chemistry), or a subsequent developer solution, to a silicon wafer substrate.

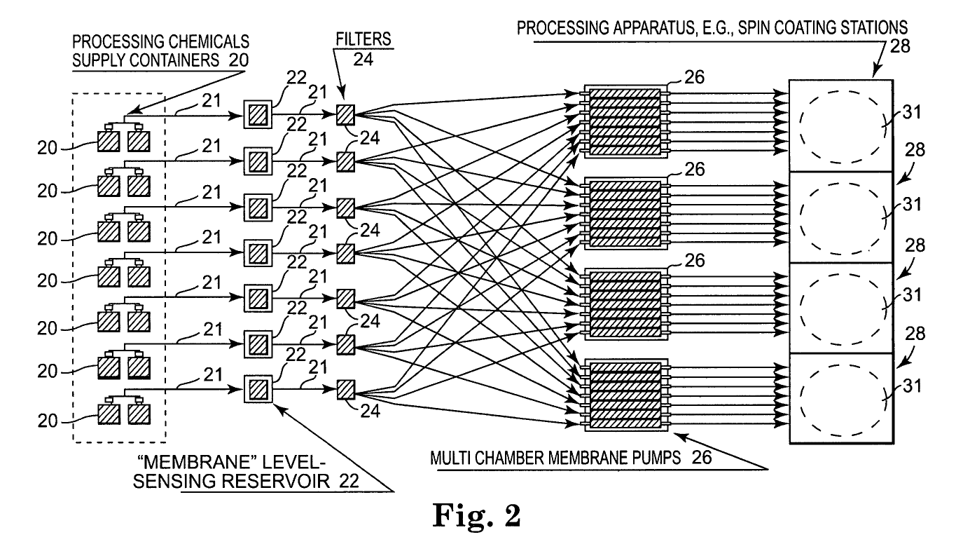

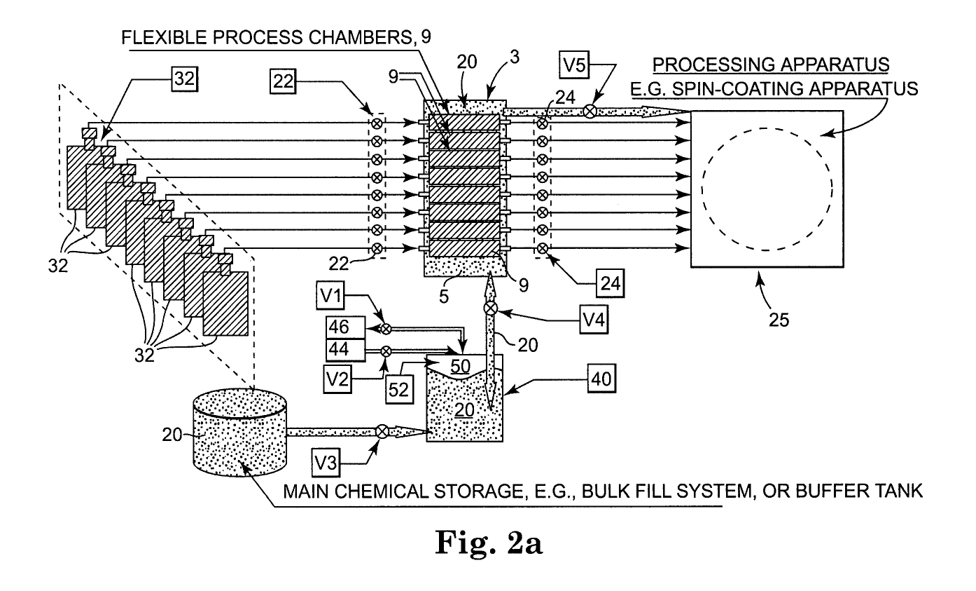

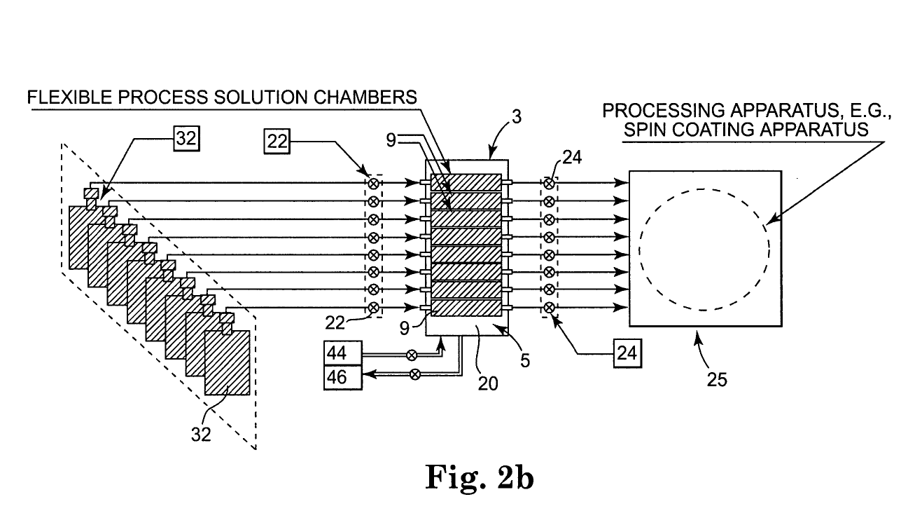

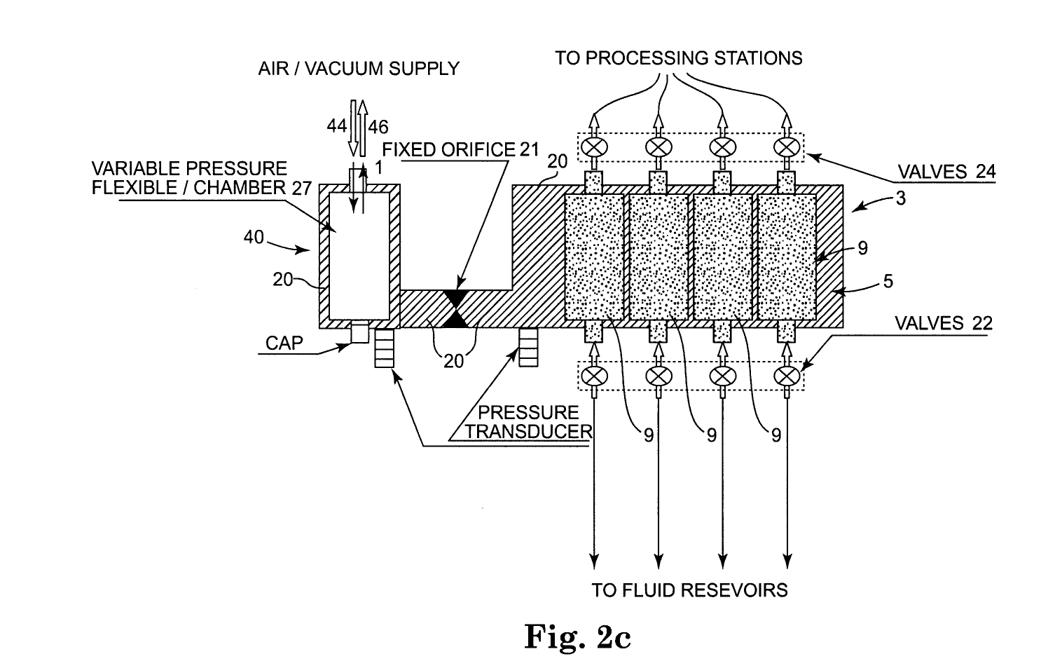

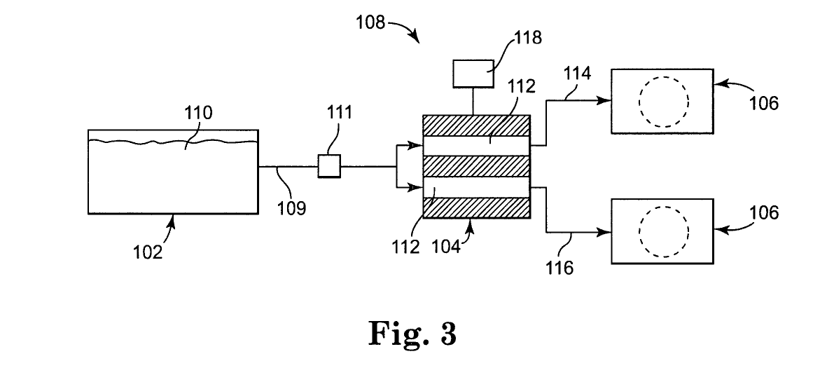

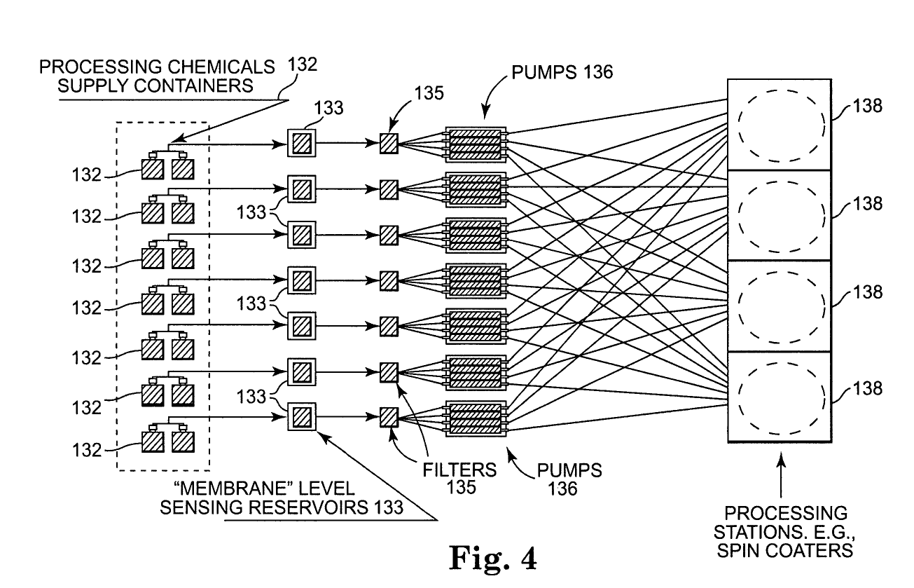

According to the invention, a multi-chamber pump can be used to control multiple flows of the same or different process fluids. The pump may be used in any of a large variety of different processing systems to process various substrates with various process fluids. In one embodiment, a system can use as many multi-chamber pumps as there are processing stations (e.g., coating devices), in which embodiment a multi-chamber pump may correspond to a single station, delivering various different process fluids to the same station (see, e.g., FIG. 2). According to other embodiments, a system may use a number of multi-chamber pumps that correspond to a number of process fluids or process fluid reservoirs, in which embodiment each pump may correspond to a single process fluid or reservoir, delivering one type of process fluid separately to a number of processing stations (which fluids may be the same type or different types) (see, e.g., FIGS. 3 and 4).

Some general advantages of using a multi-chamber pump to control more than a single flow of process fluid include the possibility of reducing the number of pumps required in a system, thereby reducing cost; the possible simplification or reduction in size, complexity, or length of portions of dispense lines and fluid flows, allowing for a reduction in the number of other required components such as filters; and, especially with certain embodiments of multi-chamber pumps, the possibility of reducing the number of moving parts to which a process fluid is exposed, and possibly the amount of movement of such parts, to reduce the amount of particle contamination entering the flow of process fluid that may become surface contamination on a processed substrate.

A multi-chamber pump can be any type of pump capable of controlling two or more fluid flows through a single pumping apparatus or unit. This may be accomplished by the use of multiple chambers, membranes, valving, or combinations of the same, per unit or apparatus. One example of such a multi-chamber pump is described in Applicants' co-pending U.S. Pat. No. 6,797,063, entitled “Dispensing Apparatus,” issued Sep. 28, 2004, the entire disclosure of which is incorporated herein by reference. Embodiments of this type of multi-chamber pump can include multiple chambers or membranes (“process chambers”) exposed to a larger chamber, i.e., a control chamber. Fluid (“control fluid”) flowing into and out of the control chamber can effect changes in the volume of each process chamber, and with separate control of inlets and outlets of each process chamber, can effect independent pumping of fluid through each process chamber for dispense.

In certain specific examples, such a multi-chamber pump may operate by exposing multiple process chambers within the control chamber, with coordinated valving, to a single control fluid pressure, to separately control the direction and amount of process fluid flow through each process chamber. Flow through one of the process chambers can be accomplished by changing the volume of that process chamber, e.g., by expanding and compressing the chamber, in combination with opening and closing inlet and outlet valves of the chamber, preferably allowing for high precision control of the flow of fluid. Such an apparatus can be used to cause a flow of fluid into and out of individual process chambers for dispensing, by controlling each of the input and output valves in combination with the volume of the process chamber. The volume of the process chamber can be controlled (i.e., increased and decreased while the valves are opened and closed) by controlling the volume and/or pressure of control fluid in the control chamber, e.g., by adding and removing control fluid to and from the control chamber, or by otherwise increasing and decreasing the pressure or volume of control fluid inside the control chamber.

An exemplary multi-chamber pump can include two or more flexible process chambers inside of a rigid control chamber. The process chambers each have an inlet and an outlet. The process chambers can be made of a material that allows the volume of the process chamber to be increased or decreased by increasing and reducing pressure at the outer surface of the process chamber where the process chamber is of a flexible material such as a flexible plastic or rubber tubing. The control chamber can be made of an inflexible material so that changing the pressure or amount of control fluid inside the control chamber (containing the process chambers) does not substantially alter the volume of the control chamber, e.g., the change of pressure of control fluid inside the control chamber will preferentially change the volume of a process chamber instead of the volume of the control chamber. Causing process fluid to flow through a process chamber can be effected as follows. Pressure inside the control chamber is reduced while a process chamber inlet is open and the outlet is closed, so the process chamber expands and increases in volume to draw process fluid into the process chamber through the open inlet. The inlet is then closed and the outlet is opened while pressure in the control chamber is increased to decrease the volume of the process chamber and expel process fluid from the outlet.

The control fluid can be any compressible or incompressible fluid, such as air, an inert gas, or any of a variety of known and commercially available hydraulic fluids such as silicones, fluoropolymers, etc.

Flow of control fluid into and out of a control chamber may be accomplished by any of a variety of useful techniques, as will be understood. Exemplary techniques may involve a control fluid reservoir connected to the control chamber and containing a supply of control fluid, wherein the volume of control fluid in the reservoir, and therefore flow of control fluid into and out of the control chamber, is controlled by controlling the volume of the reservoir. This may involve the use of a stepper motor, for example.

Alternatively, a reservoir may be closed, with a fixed volume that contains a liquid control fluid and space for a compressible or incompressible fluid (e.g., headspace or a bladder). The control fluid may be moved between the reservoir and the control chamber by changing the volume of the headspace or bladder within the reservoir, e.g., by adding or removing a compressible or incompressible fluid to and from the headspace or bladder.

A control chamber can be of any size and shape that will be useful to include a desired number of process chambers and an efficient amount of control fluid. A typical control chamber for use with one or more tubular process chambers can be tubular (cylindrical), but could also be otherwise curved, square, or rectangular, etc. The control chamber can be made of material that is relatively inflexible so that the volume of the defined control chamber will not experience a change when exposed to the pressures experienced during use. Exemplary materials could include metals and plastics, e.g. rigid materials such as a rigid tubular polyvinyl chloride, stainless steel, or another metal or hard plastic. The control chamber can be of a size that will be able to efficiently contain the process chambers, at their volumes, and that can additionally contain a workable volume of control fluid.

A process chamber of a multi-chamber pump can be of any size and shape and made of any material that will be found to be useful according to the overall description herein. Exemplary process chambers can be made of materials that are flexible so that the internal volume of the process chamber can be increased or decreased by applying different pressures to the outside of the process chamber. Preferred process chambers can be made of a tubular material with one example being a tubular fluoropolymer such as tubular Teflon®, e.g., PFA (perfluoroalkoxy) TEFLON, PTFE (polytetrafluoroethylene) TEFLON, etc.

Any volume (i.e., “static” volume, meaning volume of a process chamber in a neutral undeformed state) can be useful for a process chamber. A process chamber can be of any useful size based on factors such as the amount of fluid flow or dispense volume required from a process chamber. And, a multi-chamber pump may contain multiple process chambers each having the same or different volumes.

According to specific embodiments of the invention, for high precision applications such as semiconductor processing, a volume of a process chamber may be multiple times larger than a dispense volume (“dispense volume” is the volume of a process fluid normally dispensed during a step of a process carried out at the processing station), e.g., “static” volume of a process chamber may be from 4 to 8 times larger than dispense volume. The recited range of static volume of a process chamber relative to a dispense volume may be preferred for certain embodiments of the invention, by allowing for only relatively minor volume change during dispense, which in turn requires only slight deflection of the material defining the process chamber, which can result in a reduced amount of particles evolved from the chamber surface into the process fluid during use.

Without being bound by theory, movement or deformation of parts of a pump, and contact between moving parts of a pump, can cause particulates of material to shed from internal pump parts due to mechanical contact. Faster moving parts create more particles than slower moving parts; larger movements or greater deformation can also create more particles. Multi-chamber pumps used according to certain embodiments of the invention can reduce the number of moving parts of a pump, especially fast moving parts, and reduce the degree of deformation of process chambers, by using a relatively large process chamber in the form of a cylindrical tube that can be partially squeezed to dispense a small volume of process fluid. A tube or cylindrical-shaped chamber produces a linear (as opposed to tortuous) path of fluid flow. A relatively large static-volume tube or cylindrical-shaped chamber, compared to a dispense volume, allows for a small amount of movement or deflection of the process chamber, with slow movement of parts instead of fast movement. Additionally, a tube or cylindrical-shaped chamber can eliminate or prevent essentially all mechanical contact (e.g., touching or rubbing) between internal parts of a pump. Overall, there is a reduction in the amount of particles generated mechanically from contact between parts, from deformation of parts, and from contact between a part and a fluid.

For use with certain embodiments of the invention where high precision dispense techniques are desired, and where low particle contamination is desired, a process chamber static volume in the range from about 1 to about 500 milliliters (ml) may be useful.

For use in dispensing a photoresist solution to a spin-coating apparatus, a volume of dispense can be in the range up to a few milliliters (mls), e.g., from less than about 1 ml, up to about 5 ml. A process chamber static volume used to make such dispense may be in the range of tens of milliliters, e.g., from about 20 to about 40 ml, or about 30 ml.

As another example, for use in dispensing a photoresist developer solution, a typical dispense volume may be in the range of tens of milliliters, e.g., 30 to 60 ml, or 40 to 50 ml. A process chamber static volume can be in the range of hundreds of milliliters, e.g., 200 to 400 ml. Consequently, a multi-chamber pump that dispenses two or more different types of process fluids (to the same or a different processing station) can include process chambers that are of slightly or greatly different static volumes, e.g., volumes of different degrees of magnitude, based on the volume of a dispense that a process chamber will be used to perform for a given process fluid.

Valves can facilitate control of flow of a process fluid through a process chamber. Valves may be located at or in communication with each of the inlet and the outlet of a process chamber. One of skill will understand that these valves can be of any nature and size suitable for use with a particular process chamber and able to control fluid flow at the associated pressures, which for microelectronic processing applications are not exceedingly high, e.g., for semiconductor processing applications can generally be below about 10 atmospheres. A valve at an inlet or an outlet of a process chamber may be controlled by a separate (internal or external) control mechanism, mechanically or electronically (preferably by a high-precision electronic feedback control system), or a valve may be a one-way valve that opens and closes based on a pressure differential across the valve, allowing fluid to flow through the valve based on that pressure differential, in only one direction. High-precision valves and controls can be preferable for applications that contemplate dispense of a highly precise amount of fluid, i.e., “high precision dispense.”

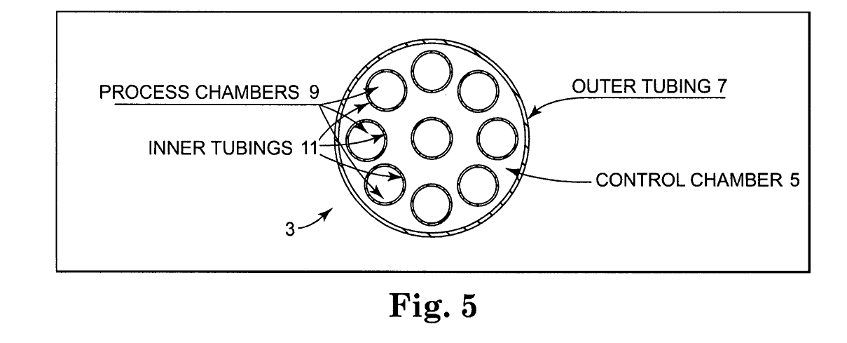

A cross section of an embodiment of a multi-chamber pump 3 for use according to the invention is shown in FIG. 5, which shows multiple process chambers 9 defined by inner flexible tubings 11 located inside of a single rigid control chamber 5 defined by outer tubing 7. As illustrated, the process chambers 9 are all shown to be of similar diameters, but they are not required to be.

Still referring to FIG. 5, each of the different process chambers 9 can be used as described above to dispense a different or the same type of process fluid to a different or the same processing station (e.g., coating station). For instance, one of the process chambers 9 can be used to dispense a photolithographic photoresist material, and another process chamber 9 of the same apparatus 3 can be used to dispense water or another process fluid, e.g., used in combination with photoresist material. Alternately, according to other architectures, two process chambers 9 can be used to dispense the same process fluid, e.g., photoresist, to two different processing stations.

FIG. 2a illustrates a system exemplifying the use of a multi-chamber pump such as the pump shown in FIG. 5. FIG. 2a illustrates a pump 3 that contains a number of flexible process chambers 9, e.g., made of thin-wall TEFLON tubing. Each process chamber 9 is connected through an inlet valve 22 to one of several fluid reservoirs 32. The individual reservoirs 32 may all contain the same process fluid, all different process fluids, or some of the same and some different process fluids. Each process chamber 9 also connects through an outlet valve 24 leading to a point of dispense, such as a process bowl of a spin-coating apparatus or another processing station, 25. By individually controlling the inlet and outlet valves, 22 and 24, related to each of the individual process chambers 9, in combination with the pressure and/or volume of control fluid 20 in control chamber 5, any one of the fluids from each of the reservoirs 32 can be precisely dispensed.

In the apparatus of FIG. 2a, the pressure within the control chamber 5 is controlled by a control fluid 20 flowing from control fluid reservoir 40, the pressure of which is in turn controlled by regulated pressure 44 and regulated vacuum 46. Regulated pressure 44 and vacuum 46 can control pressure of a compressible (e.g., gaseous) fluid 50 into headspace 52 of reservoir 40. The gaseous fluid 50 can be, for example, air or an inert gas such as nitrogen. Increasing or decreasing the pressure or volume of fluid 50 in headspace 52 of reservoir 40 can cause control fluid 20 to flow back and forth between fluid reservoir 40 and control chamber 5. Control fluid 20 can be, for example, a liquid such as water or a hydraulic fluid, e.g., a silicone or fluorocarbon hydraulic fluid, or any other, preferably substantially non-compressible liquid. In certain embodiments, control fluid 20 may itself be a process fluid useful in a processing station, (e.g., water, deionized water, or cleaning solvent), and as such may flow from the control chamber to a processing station (through valve V5).

In yet another embodiment, illustrated by FIG. 2b, the control fluid 20 may be a compressible fluid (e.g., air, nitrogen, etc.) as illustrated, with regulated vacuum 44 and regulated pressure 46 directly applied to control chamber 5.

In still other embodiments of the invention, which are not presently illustrated, a control fluid system such as the fixed-volume reservoir 40 with headspace of FIG. 2a, or the vacuum system of FIG. 2b, can be replaced by a variable volume reservoir that causes an incompressible control fluid to flow between the reservoir and the control chamber 5. The volume of the reservoir can be controlled by any technique or equipment, and is preferably controlled by equipment that allows for high precision exchange of a substantially fixed volume of control fluid between the variable volume reservoir and the control chamber, for example equipment that includes a stepper motor.

FIG. 2c illustrates another exemplary embodiment of a system useful for dispensing process fluid including a photoresist solution to a spin-coating station, by use of a multi-chamber pump as described. As shown in FIG. 2c, a system can include control fluid 20 that can flow between a control chamber 5 and a reservoir 40, through fixed orifice 21. Instead of a “headspace” in the reservoir 40, a flexible chamber (or flexible bladder of tube) 27 can be expanded and contracted, to take up more or less of the fixed volume of reservoir 40. Regulated pressure 44 and vacuum 46 are delivered to chamber 27, to control the volume and size of chamber 27 within reservoir 40, and cause control fluid 20 to move between reservoir 40 and control chamber 5. As illustrated, both of the control fluid reservoir 40 and the control chamber 5 are equipped with an electronic pressure transducer. When the flexible chamber 27 is forced to expand, the control fluid flows into the adjacent control chamber 5 of multi-chamber pump 3, and causes the pressure to increase. With control of inlet and outlet valves 22 and 24, pressure differential between the control chamber 5 and process chambers 9, can produce flow of process fluids from fluid reservoirs (not shown), through the multi-chamber pump 3, to one or more processing stations (not shown).

Also useful in embodiments of high precision dispensing apparatus can be a high precision, feedback control, pressure regulating system, to control the amount and pressure of control fluid in the control chamber, optionally and preferably in combination with control of inlet and outlet valves of process chambers. Useful high precision electronic pressure or fluid flow regulating devices will be known by the skilled artisan, and are commercially available from a number of sources, including SMC, of Japan. Preferred such pressure regulating devices can control timing of flow, e.g., timing of opening and closing of input and output valves, to a matter of milliseconds, more preferably to a matter of less than a millisecond, and even more preferably to a matter of much less than a millisecond.

A preferred electronic control system can include one or more pressure sensors such as pressure transducers to measure pressures of fluids within a dispensing system for feedback control, such as the control fluid pressure or a process fluid pressure. A pressure sensor can, for example, be located at or within the control chamber, or multiple separate pressure sensors could be located at or within one or more process chambers. Either of these arrangements could provide a useful system.

A location for a pressure sensor in a spin-coating apparatus for dispensing microelectronic device process fluids according to the invention can be in a dispense line at or near a processing station or other point of dispense, e.g., at a dispense head inside a processing chamber of a processing station. Placing a pressure sensor near the point of dispense, e.g., at a dispense head or in a dispense line near the point of dispense, can advantageously eliminate certain variabilities associated with the control chamber and process chamber volumes, allowing for improved precision of the volume of dispensed fluid (see e.g., U.S. Ser. No. 10/271,525, entitled SPIN COATING METHODS AND APPARATUSES FOR SPIN-COATING, INCLUDING PRESSURE SENSOR, filed Oct. 15, 2002, the entirety of which is incorporated herein by reference).

As described, and as will be understood, the inventive methods, systems, architectures, and apparatuses can be used to efficiently supply process fluids to stations that process microelectronic devices such as microelectronic devices, semiconductor wafers, and the like. The present disclosure describes and exemplifies inventive methods and apparatuses as they are used in such applications. Still, the invention would be similarly useful in many other industrial and commercial applications, as will be understood by the skilled artisan, such as with other processing techniques where it may be advantageous for any reason (e.g., cost or quality control, uniformity, etc.) to control with high precision an amount of a process fluid dispensed, e.g., applied to any substrate.

Generally, systems of the invention may involve the use of one or preferably two or more multi-chamber pumps, preferably two or more processing stations such as coating stations, and two or more flows of the same or different types of process fluid, especially multiple flows of a variety of process fluids. The multi-chamber pump or pumps, process fluid reservoirs, processing stations, and necessary or optional related appurtenances, can be arranged into systems or architectures that take advantage of the use of multiple flows of process fluid through the multi-chamber pump or pumps, to reduce overall cost and complexity of the system or improve product quality, for example by reducing the number of filters required, the number of individual pumps required, etc., reducing particulates or other defects, or increasing uniformity.

Advantages result from the use of one or more multi-chamber pumps within a variety of possible systems or apparatus. Each multi-chamber pump in a system contains at least two, typically more, process chambers. Each process chamber can control a separate flow of a process fluid; the different “flows” of process fluid may be flows of the same or different types of process fluid, e.g., photoresist, developer solution, dielectric, deionized water, solvent, cleaner, etc. Depending on the particular processing arrangement and number of pumps, processing stations, and process fluids or process fluid reservoirs, separate process chambers in any individual multi-chamber pump of any arrangement can control flow of the same type of process fluid, or different types of process fluid. And, the different process chambers of any individual pump within a system may be connected at their inlet ends to the same or different process fluid reservoirs, or at their outlet ends to the same or different processing stations.

In particular, in certain embodiments, two or more process chambers of a multi-chamber pump in a system may deliver separate flows of two or more different types of process fluids originating from different process fluid reservoirs, to a single processing station. See, e.g., FIGS. 2, 2a, and 2b. According to other particular embodiments, two or more process chambers of any pump in a system may also deliver separate flows of the same type of process fluid, optionally taken from the same process fluid reservoir, to different processing stations. See, e.g., FIGS. 3 and 4. This provides for a very large variety of different possible system architectures when using one or more multi-chamber pumps to deliver flows of process fluids to one or more processing station

One example of an apparatus of the invention can use one multi-chamber pump to dispense two or more different types of process fluids to a single processing station. This can be accomplished by including two or more process chambers in a single multi-chamber pump, with process chambers of the same pump connected to sources of different process fluids, the different process chambers being enclosed in a single control chamber and each process chamber being independently valved at an outlet and an inlet. The different process chambers of the multi-chamber pump can be of the same, similar, different, or dissimilar sizes (volumes), dimensions (e.g., length or diameter), and materials. The process fluids can be selected as combinations of process fluids such as fluids used to perform any particular type of process on a substrate. For example, to supply various different process fluids to an apparatus for spin-coating a semiconductor wafer, a single pump may provide process fluids through multiple process chambers, the process fluids including any one or a combination of a photolithographic photoresist solution, a developer solution, deionized water, one or more surface conditioning solutions such as an acid and a base, among others.

According to the invention, a system or architecture may include one, two, or more multi-chamber pumps. Two or more multi-chamber pumps can be arranged to supply more than one set of process fluids to two separate processing stations. For example, two to several multi-chamber pumps of a processing system may individually and exclusively corresponds to and be used to supply an identical set of process fluids to the same number of processing stations operating in parallel. Such an arrangement of multi-chamber pumps and processing stations might be of particular convenience and cost efficiency when, in an architecture, the number of processing stations is fewer than the number of different types of process fluids supplied to each station. According to this arrangement, each multi-chamber pump can receive flows of different process fluids from different sources or reservoirs, typically including a number of different types or compositions of process fluids that are used by the processing stations. Each of the process fluids supplied to the number of individual pumps may originate from a single process fluid reservoir (one reservoir per process fluid supplies more than one pump). Overall, the total number of process chambers in all of the total number of pumps, can approximate or equal the number of processing stations multiplied by the number of different types of process fluids or the number of process fluid reservoirs used (optionally but not necessarily, if there are more reservoirs than different process fluids). An advantage of using multi-chamber pumps in this arrangement is that to dispense multiple different process fluids to each processing station, only one multi-chamber pump is required per station instead of multiple pumps for each processing station, one pump for each process fluid per station.

Also according to embodiments of the invention, one multi-chamber pump can control multiple flows of the same type of a process fluid to two or more separate processing stations. According to this arrangement, one, two, or more multi-chamber pumps of a system can each be dedicated to control separate flows of one single type of process fluid to each of a number of individual processing stations. One multi-chamber pump can dispense multiple flows of a single type of process fluid, e.g., one flow of process fluid for each process chamber of the pump, with the number of flows of the process fluid optionally being equal to the number of processing stations to which the process fluid flows will be delivered from the multi-chamber pump. The separate flow of process fluid dispensed from the multi-chamber pump can be from one source, and can be separated into separate flows from multiple process chambers of the multi-chamber pump. The multi-chamber pump controls the multiple flows of the single type of process fluid, distributing separate flows of the same process fluid to two or more individual processing stations. Optionally and preferably, more than one of such multi-chamber pumps can be used within a single system, architecture, or apparatus, with each pump corresponding to one process fluid, e.g., exclusively. Also optionally, if desired, a pump that controls two or more flows of a same process fluid can also control one or more flows of different process fluid or fluids.

Still according to these arrangements, two or more multi-chamber pumps can be arranged in parallel to provide a number of different process fluids to each of multiple processing stations. If one pump corresponds to one process fluid, or roughly so, a total number of pumps can equal or approximate the number of process fluids, and the number of process chambers in each pump can be at least as many as the number of processing stations. This arrangement may be particularly efficient or convenient if a number of process fluids in a system to be delivered to each processing station is less than the number of processing stations. Again, the number of process chambers in all of the pumps can approximate or equal the number of processing stations multiplied by the number of different types of process fluids or the number of process fluid reservoirs.

One specific embodiment of such an arrangement for supplying multiple process fluids to multiple processing stations, according to the invention, is illustrated at FIG. 2. FIG. 2 shows process fluid reservoirs 20, which may each contain the same or different process fluids, but which preferably, to realize certain advantages of the inventive arrangement, contain different process fluids to supply process fluid flows of different process fluids (seven as illustrated) to each of the illustrated processing stations 28 (four as illustrated). Multi-chamber pumps 26 are shown to include process chambers within a control chamber. FIG. 2 shows the use of seven process chambers per multi-chamber pump 26. This amount corresponds to the illustrated use of seven process fluid reservoirs 20. More or fewer process chambers could be included in any one or more of the four multi-chamber pumps 36, if the system required more, fewer, or a different combination of process fluid flows to any one or more of the four processing stations 28 (illustrated as spin-coating apparatus, containing substrates 31). Also, FIG. 2 shows all four pumps 26 being used to deliver each of the same process fluids to all four stations 28. Alternately, any one or more of the four pumps could deliver different fluids or combinations of fluids, e.g., more than seven supply containers 20 could supply fluids to pumps 26, with one or more supply containers being connected to fewer than the total number of pumps 26.

According to the exemplary arrangement of FIG. 2, four multi-chamber pump are used, each pump corresponding to one processing station. The total number of process chambers in four pumps is seven process chambers times four pumps, for twenty-eight. All four processing stations can be similar or the same, however this is not necessary.

Referring to certain possible details of the arrangement of FIG. 2, process fluids flow through separate dispense lines 21, from each of the process fluid reservoirs 20, through level-sensing reservoirs 22, and filters 24, to each of the pumps 26. Control fluid for each of the pumps is independently dispensed and controlled from a separate control fluid reservoir (not shown) for each of the separate pumps 26. There is one control fluid reservoir 20, and filter 24, per multi-chamber pump 26. In combination with each control fluid reservoir, each pump 26 can include valving and controls to allow independent control of the flow of each process fluid through a process chamber of each pump 26 and to each processing station 28.

Still referring to FIG. 2, filters 24 can filter each flow of process fluid between reservoirs 20 in pumps 26. Placed upstream of the pumps 26, and with separation of dispense lines between each fluid reservoir 20 and individual pump 26, only a single filter 24 is needed for each supply of process fluid to all of the multiple stations 28. According to the invention, and as illustrated, filters 24 can be located upstream from the pump 26 because of the reduced particulates that evolve from certain preferred multi-chamber pumps 26 as described herein.

With filters 24 upstream of pumps 26, reservoirs 20 or 22 preferably include a pump that can produce a flow of process fluid through the filter 24, such as a reservoir that includes a gas over a fluid, wherein the gas can pressurize the process fluid to flow through the filter 24 and to the multi-chamber pump 26. Examples of such reservoirs include pressure dispensers available under the trade name NOWPAK® pressure dispense systems (e.g., “Bottle in a Bag”), which are able to maintain a supply of process fluid and dispense the process fluid based on the use of a pressurized gas and vacuum system, while also monitoring the level of the process fluid in the reservoir.

Specific examples of reservoirs that are preferred for use according to the invention can be those that can produce pressure and flow of the process fluid, while preventing or reducing gasification of the fluid. Also desirable is that the reservoir can be monitored for the amount of processing fluid remaining. Direct contact between the process fluid and a pressurizing gas in the reservoir can cause the pressurizing gas to become absorbed by the process fluid, prior to the process fluid being used for processing. If the gas becomes absorbed in the process fluid, the gas may later evolve from the process fluid during a downstream process, creating a bubble in the process fluid that can produce a processing defect at a substrate surface. Additionally, bubbles in a process fluid at the processing station can create unwanted variance in the volume measurement of the process fluid. Thus, gasification of the process fluid is preferably avoided.

A reservoir designed to prevent gasification of the process fluid may be of a type that includes an amount of process fluid, an amount of gas that can be pressurized to control flow of the process fluid from the reservoir, and a gas-impermeable membrane that separates the process fluid from the gas to prevent the gas from becoming absorbed in the process fluid, i.e., a “membrane reservoir.” In specific, the use of a membrane reservoir allows the reservoir to be pressurized, to pressurize the process fluid flowing to a filtration and pump system, without the process fluid contacting a pressurizing gas such as nitrogen (N₂), which could otherwise dissolve into the process fluid. This system could be located remote from a pump or processing station and could support great distances and elevations if desired. Further, a membrane barrier between the pressurizing gas and the process fluid allows refilling of a membrane-type reservoir without running the risk of any process fluid going into the vacuum hardware network.

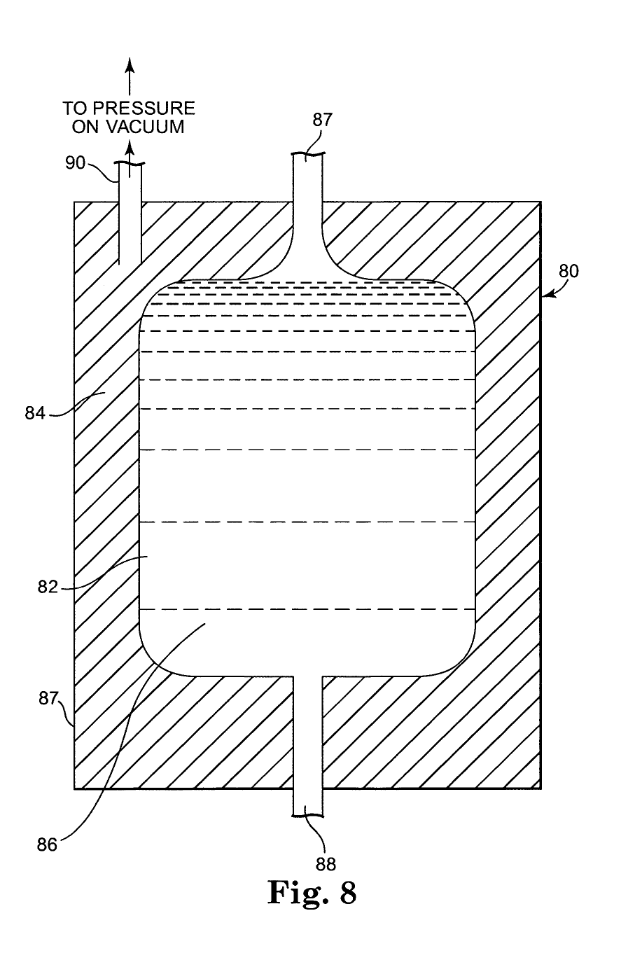

An example of a reservoir that separates a pressurizing gas from a process fluid using a flexible membrane, e.g., a “membrane-type reservoir,” is illustrated in FIG. 8. FIG. 8 shows a rigid reservoir body or case 80, that contains membrane 82, which is flexible and can be folded or stretched as necessary to define an inside volume of the membrane 82 to contain process fluid 86. Case 80 also contains pressurized gas 84, external to the membrane 82 but internal to body 80. Control of the volume or pressure of pressurizing gas 84 can be used to cause desired volumes of process fluid 86 to flow from inlet 87, through the reservoir, and out of outlet 88. Valves at inlet 87 and outlet 88 are not shown. Process fluid 86 does not contact pressurizing gas 84, so there is no potential for gasification of process fluid 86 by the gas 84. Further, process fluid 86 cannot contact the pressure/vacuum inlet/outlet 90, which means that process fluid 86 is not able to come into contact with or potentially contaminate a pressure or vacuum supply (not shown), in communication with gas 84, that is used to control the volume or pressure of processing fluid 86 within the reservoir.

In certain specific embodiments of the invention, a system can use two fluid reservoirs for one process fluid, either or both of which may include a membrane that separates the process fluid from the pressurizing gas. The two reservoirs may be in series or in parallel. The use of two reservoirs, either in series or parallel, supports high throughput through a system and the processing station or tool.

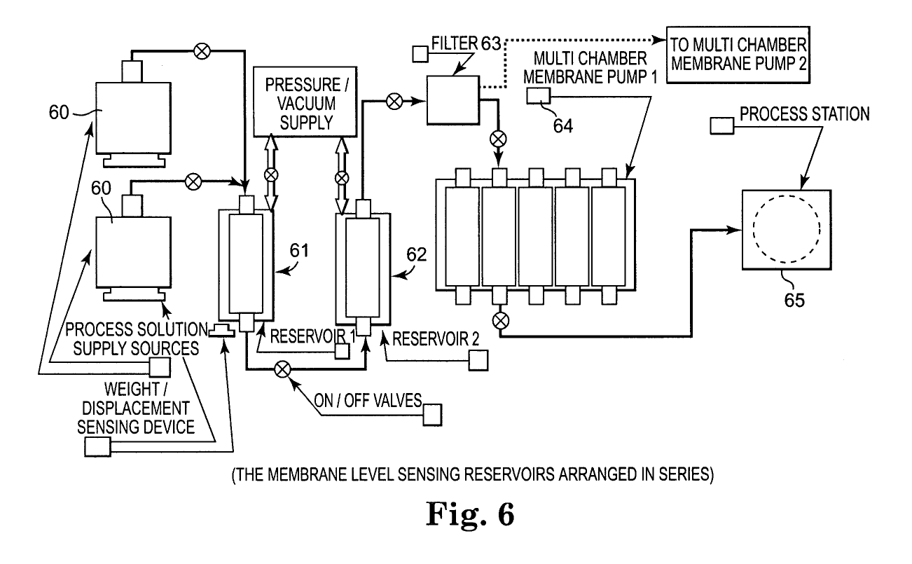

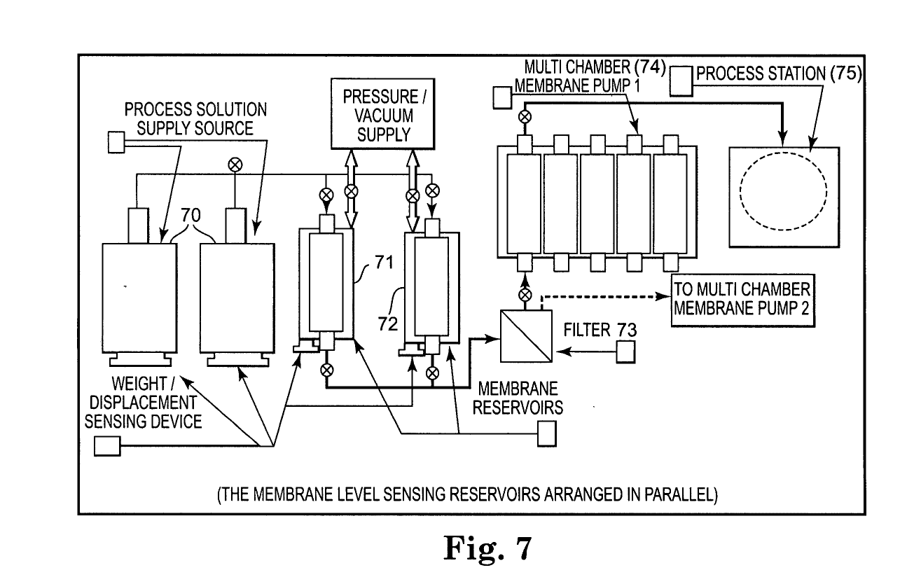

Examples of certain details of various embodiments of this arrangement are shown at FIGS. 6 and 7. FIG. 6 shows process solution supply sources 60 connected to a first reservoir (Reservoir 1), 61. The first reservoir is connected in series through a valve to a second reservoir (Reservoir 2), 62. Reservoir 1 and Reservoir 2 are illustrated to be membrane-type reservoirs as exemplified in FIG. 8. Process fluid flows from sources 60 to first reservoir 61, then to second reservoir 62, then through filter 63 and to multi-chamber membrane pumps 1 (64) and 2 (not shown). Each of the process fluid supply sources 60, and first reservoir 61, are illustrated to include weight displacement devices for sensing the level of process fluid contained by the sources and reservoirs, e.g., to identify a full, empty, or near-empty condition, or by other level-sensing technologies. The process fluid finally flows from each multi-chamber pump to a process station; e.g., from multi-chamber pump 64 to process station 65. Process station 65 may be any useful processing station, such as a spin coating station.

An advantage of an in-series configuration as illustrated with reservoirs 61 and 62 is that a simpler hardware implementation can be used. The in-series configuration of reservoirs. 61 and 62 allows the downstream reservoir 62 to not require a weight or displacement sensor to monitor fill state. Reservoir 62 can be maintained at a constant pressure while reservoir 61 draws fluid from supply sources 60 and refills reservoir 62. The two reservoirs 61 and 62 can be sized so that reservoir 61 fills at a rate more than twice the fluid dispense rate of multichamber pump 64. This allows reservoir 61 to fill from the source and then refill before reservoir 62 empties beyond a minimum desired volume. This also allows reservoir 62 to maintain a constant pressure to the filter 63 and multichamber pump 64 regardless of the refill function. The constant fluid pressure to the pump allows for the multichamber pump 64 to dispense at any time desired. The ability to operate without the extra weight or displacement sensor allows for a simpler and less expensive implementation.

FIG. 7 shows process fluid supply sources 70 connected to a first reservoir (Reservoir 1) 71 and also connected in parallel to a second reservoir (Reservoir 2) 72. Reservoirs 1 and 2 are illustrated to be membrane-type reservoirs as exemplified at FIG. 8. Process fluid flows from sources 70 to reservoirs 71 and 72, in parallel, then alternately or together from reservoirs 71 and 72, through filter 73, and then to multi-chamber membrane pumps 1 (74) and 2 (not shown). Each of the process fluid supply sources 70, and first and second reservoirs 71 and 72, are illustrated to include weight displacement devices for sensing the level of process fluid contained by the sources and reservoirs, e.g., to identify a full, empty, or near-empty condition, or by level-detection by other level-sensing technologies. The process fluid finally flows from each multi-chamber pump to a process station; e.g., from multi-chamber pump 74 to process station 75. Process station 75 may be any useful processing station, such as a spin coating station.

An advantage of the parallel configuration of reservoirs 71 and 72 is that the parallel configuration allows the two reservoirs 71 and 72 to operate independently and alternately supply fluid pressure to the downstream filter. In this mode of operation each of the reservoirs has full sensing and control capability. Each reservoir can be able to refill before the other is emptied by supplying fluid needed for dispense.

FIG. 3 illustrates an embodiment of the invention wherein one multi-chamber pump controls multiple (two or more) flows of one type of process fluid to multiple (two or more) separate processing stations, e.g., as part of a larger system or architecture. FIG. 3 illustrates the use of one multi-chamber pump 104 to control two separate flows 114 and 116 of one type of process fluid to two separate processing stations 106. Referring to FIG. 3, arrangement 108 includes process fluid reservoir 102, multi-chamber pump 104, and two processing stations 106 (which may be the same or different, here, illustrated as two coating stations). Process fluid 110 contained by reservoir 102 is in fluid communication with each of two process chambers 112 of multi-chamber pump 104. One filter 111 may optionally and preferably be included in the single supply line 109 between reservoir 102 and pump 104, prior to branching. From multi-chamber pump 104, each process fluid flow (designated 114 and 116) of the process fluid 110, is separately directed to each of the two processing stations 106. Control fluid reservoir 118 in combination with valving (not shown) is used to independently effect these two separate flows by increasing or decreasing the pressure or volume of control fluid in a control chamber of pump 104.

The arrangement of FIG. 3 illustrates the use of a single multi-chamber pump to control separate flows 114 and 116 of the same process fluid 110. FIG. 3 illustrates an exemplary embodiment of the invention by which a single pump can correspond to a single process fluid or a single process fluid reservoir. According to this arrangement in a larger system, a number of such pumps can correspond to any desired number of process fluids (or fluid reservoirs) to be dispensed for use at a number of processing stations.

As another example of a system of FIG. 3, the system can be supplemented with more processing stations 106, in which case multi-chamber pump 104 could include one more process chamber 112 for each additional processing station. Additionally, the system could include the use of additional process fluids, in which case one multi-chamber pump and one process fluid reservoir could be added for each additional process fluid. The additional multi-chamber pump or pumps could include one process chamber for each processing station 106, and fluid connections. Other equipment and appurtenances such as pumps, process fluid reservoirs, process fluid flows, processing stations, and process control equipment, in addition to those illustrated in FIG. 3, can be used in such a system in accordance with the invention.

In the event that the same process fluid is used inside multiple, e.g., all process chambers of a single multi-chamber pump, an additional benefit is a reduction in “cross talk.” Traditional pumps have a certain level of “cross talk” between the process flows when simultaneously dispensing a process fluid, e.g., through a manifold of connected dispense lines. The use of a multi-chamber pump as described herein can reduce or eliminate that problem because the outputs are separate, and not connected by a manifold.

FIG. 4 illustrates in greater detail an embodiment of the invention according to FIG. 3. Referring to FIG. 4, illustrated system 130 includes fourteen different process fluids in process fluid reservoirs 132 (or “supply containers”) (two for each of seven flows of process fluid), seven multi-chamber pumps 136 (each containing four chambers), and four processing stations 138, along with supply lines for supplying each process fluid from each process fluid reservoir 132, through level-sensing reservoirs 133, through filters 135, to each multi-chamber pump 136, and then to each processing station 138.

FIG. 4 illustrates an embodiment of the invention that uses one multi-chamber pump to separately deliver each of a number of different process fluids to multiple processing stations. Other equipment and appurtenances such as pumps, process fluid reservoirs, process fluid flows, processing stations, and process control equipment, in addition to those illustrated in FIG. 4, can be used in such a system in accordance with the invention. For example, while FIG. 4 illustrates that all seven fluids are delivered to each of stations 138, the stations may not all require or use identical combinations of fluids, and additional supply containers 132, and optionally additional pumps 136 can be included in such a system to deliver other fluids to one or more (e.g., less than all) of processing stations 138.

Other embodiments of apparatus, architectures, and systems using multi-chamber pumps to supply process fluid flows to processing stations will be appreciated by those of skill. As such, the illustrated and described embodiments are only exemplary and are in no way intended to imply any limitations as to the scope of the invention or to identify exclusive or required elements or features of the invention. The illustrations and related text identify exemplary embodiments that may constitute an entire system or architecture according to a practice of the invention, or only a portion of a larger system or architecture.

The illustrated and discussed embodiments can be depictive of only a portion of a larger system, apparatus, or architecture that may also include additional elements or features that are not illustrated or that are not discussed herein. Such a portion of a larger system is also contemplated to be and is part of the present invention and claims, even if such additional components or features are added to the embodiments illustrated herein. The described and illustrated systems are not exclusive of any other components and may include additional pumps (multi-chamber, single chamber, or otherwise); additional coat stations or other types of processing stations; the use of process fluid flows to or from some or all of a total number of multi-chamber pumps of a larger system, to or from a process fluid reservoir, or to or from a processing station, in addition to those illustrated. This means, for example, that a system contemplated as embodying the invention, in addition to the use of one or more multi-chamber pumps to control process fluid flows as described herein, can additionally include flows of fluid by other, e.g., single-chamber or multi-chamber pumps, to or from a single or multiple reservoirs or processing stations. Moreover, while certain of the preferred systems of the invention may be described as involving one multi-chamber pump corresponding to one processing (e.g., coating) apparatus, or one multi-chamber pump corresponding to each type of process fluid delivered to multiple processing apparatus, such one-to-one correspondence is not a requirement of the invention, and other arrangements may be used, e.g., with partial correspondence of one or more multi-chamber pump or pumps to specific process fluids or reservoirs, or with partial correspondence of one or more pumps to specific processing stations.

Embodiments of systems or architectures of the invention can include any number of single chamber pumps, multi-chamber pumps (at least one), process fluids, and processing stations, including a number X of spin coating stations, each station designed to have a number Y of dispense points, supplied by Z chemistries, wherein Z is less than the value of X times Y. When Z=X*Y, the system would include one pump per dispense point.

Systems of the invention do not require the same numbers or types of process fluids being dispensed at all processing stations, or the same number or types of fluids flowing through all or multiple multi-chamber pumps. Any variations or combinations of amounts of pumps, processing stations, and fluids and fluid reservoirs, in combination with one or more multi-chamber pumps as described herein, are contemplated, as well as any variation or combination of process fluids being dispersed at two or more process stations or being delivered by two or more multi-chamber pumps. The combinations of such flows can be adjusted based on factors that include business preferences and efficiencies.

As only one example, some systems may include certain process fluid chemistries that require high throughput capabilities, and certain other process fluid chemistries that do not require high throughput. To accommodate such a situation, a low throughput chemistry may be caused to flow to fewer than a total number of processing stations, e.g., one or two processing (e.g., spin-coating) stations, while the high throughput chemistry may be used on all or most of the total number of processing stations. This causes the “Y” dispense points across the “X” stations, to not all deliver an identical combination of chemistries. The following table exemplifies such a system. It shows a configuration with X=4 spin-coating stations, Y=4 dispense flow points per coating-station, and Z=7 chemistries.

| Chemistry # | Station 1 | Station 2 | Station 3 | Station 4 |
|---|---|---|---|---|
| 1 | Nozzle 1 | Nozzle 1 | Nozzle 1 | |
| 2 | Nozzle 2 | Nozzle 2 | Nozzle 2 | |
| 3 | Nozzle 3 | Nozzle 3 | Nozzle 3 | |
| 4 | Nozzle 4 | | | Nozzle 1 |
| 5 | | Nozzle 4 | | Nozzle 2 |
| 6 | | | Nozzle 4 | Nozzle 3 |
| 7 | | | | Nozzle 4 |

This configuration allows for three processing (e.g., spin-coating) stations to provide a higher parallel throughput capacity from for substrates treated with chemistry 1, 2, and 3, a lower throughput capacity from 2 parallel processing stations from chemistries 4, 5, and 6, and a single spin processing station to support chemistry 7. This type of arrangement may be used to match throughput capacity to a large chemistry set with a limited number of dispense points. The variable dispense point may be desired for process development or test purposes.

1. An apparatus for processing substrates, the apparatus comprising
two processing stations equipped to dispense at least two different process fluids, and
two multi-chamber pumps each comprising two process chambers, each process chamber in fluid communication with a processing station.

2. The apparatus of claim 1 wherein the processing stations are spin-coating devices.

3. The apparatus of claim 2 wherein each process chamber comprises a process fluid input connected to a process fluid reservoir, and a process fluid output connected to a spin-coating device, wherein two flows of process fluid can be independently controlled, one flow through each of the two process chambers.

4. The apparatus of claim 2 wherein a multi-chamber pump contains two or more process chambers dispensing two or more different process fluids to one spin-coating station, the process fluids comprising two fluids selected from the group consisting of a photoresist, a developer, a solvent, a cleaner, and water.

5. The apparatus of claim 1 wherein a process chamber is defined by an at least partially flexible tube.

6. The apparatus of claim 5 wherein the tube comprises a flexible fluoropolymer.

7. The apparatus of claim 5 wherein the tube is elongated and sized to reduce flex in the tube during process fluid dispense, to limit particle evolution from the tube.

8. The apparatus of claim 7 wherein a static volume of the process chamber is from 4 to 8 times a dispense volume of the process chamber.

9. The apparatus of claim 7 wherein a static volume of the process chamber is from 1 to 500 milliliters.

10. The apparatus of claim 1 wherein two process chambers of one pump control flows of two different process fluids to one spin-coating apparatus.

11. The apparatus of claim 10 wherein the two flows of process fluid are flows of different types of process fluid.

12. The apparatus of claim 1 wherein two process chambers of one pump control two flows of process fluid to two different a spin-coating apparatus.

13. The apparatus of claim 12 wherein the two flows of process fluid are flows of the same type of process fluid.

14. The apparatus of claim 1 comprising, for each of two multi-chamber pumps,
a control chamber that encloses process chambers and a liquid control fluid,
a control fluid reservoir in fluid communication with the control chamber, the control fluid reservoir containing
liquid control fluid in fluid communication with the control chamber, and
space comprising compressible fluid,
an inlet of each process chamber connected through an inlet valve to a process fluid reservoir, and
an outlet of each process chamber connected through an outlet valve to a spin-coating station.

15. The apparatus of claim 1 comprising
an amount X, equal to two or more, of spin-coating stations, each spin-coating station designed to dispense a number Y, equal to two or more, of flows of process fluid,
an amount X of multi-chamber pumps, one multi-chamber pump for each spin-coating station, each multi-chamber pump for supplying the Y different process fluids to a single one of the X spin-coating station.

16. The apparatus of claim 15 further comprising Y process fluid reservoirs, each process fluid reservoir separately connected to and in fluid communication with each one of the X multi-chamber pumps.

17. The apparatus of claim 1 comprising
an amount A, equal to two or more, of spin-coating stations, each station designed to dispense a number B, equal to two or more, flows of process fluid,
an amount B, equal to two or more, of process fluid reservoirs, and
an amount B of multi-chamber pumps, each multi-chamber pump comprising A process chambers, wherein process chambers of each pump are connected at inlet ends to a same process fluid reservoir, and outlet ends of those process chambers are connected to at least two different spin-coating stations.

18. Processing apparatus comprising
two processing stations, and
a multi-chamber pump comprising two process chambers, one process chamber in fluid communication with each processing station.

19. The apparatus of claim 18 wherein the two process chambers separately supply the same process fluid from one process fluid reservoir to each of the processing stations.

20. The apparatus of claim 18 comprising
a number X, equal to two or more, of processing stations, which are spin-coating stations, and
a multi-chamber pump comprising X process chambers, at least one process chamber from the pump in separate fluid communication with each of the X spin-coating stations.

21. The apparatus of claim 20 wherein
each one of the X processing stations dispenses Y process fluids,
the apparatus comprises a number Y of multi-chamber pumps,
each one of the Y multi-chamber pumps comprises X process chambers, and
at least one of the X process chambers from each of the Y multi-chamber pumps is in separate fluid communication with each of the X processing stations.

22. An architecture for dispensing multiple process fluids to multiple processing stations, the architecture comprising
two or more processing stations, each station dispensing multiple process fluids, each station in fluid communication with at least one multi-chamber pump, and
two or more multi-chamber pumps comprising multiple chambers, each chamber having an inlet and an outlet, the inlet in fluid communication with a reservoir of process fluid, and the outlet in fluid communication with a processing station.

23. The architecture of claim 22 comprising
a number of multi-chamber pumps equal to the number of processing stations, one pump corresponding to one station,
process fluid reservoirs in fluid communication with process chamber of the pumps, and
multi-chamber pumps providing multiple different process fluids to a single station.

24. The architecture of claim 22 comprising
a number of multi-chamber pumps equal to a number of process fluid reservoirs, one pump corresponding to one reservoir,
process fluid reservoirs in fluid communication with only one multi-chamber pump, and
wherein one multi-chamber pump provides the same process fluid from one process fluid reservoir to two stations.

25. A processing method comprising
providing two processing stations, each station equipped to dispense two or more process fluids,
providing a multi-chamber pump for each processing station, each pump supplying two or more process fluid flows to a processing station, and
dispensing process fluid to a processing station through the multi-chamber pump.

26. A processing method comprising
providing two multi-chamber pumps,
providing two different process fluids, one process fluid in communication with a process chamber of each multi-chamber pump, and
dispensing both of the two process fluids to a single processing station.
